(19) United States
(12) Patent Application Publication
(10) Pub. No.: US 2003/0010319 A1
(43) Pub. Date: Jan. 16, 2003

(54) Fuel injection device

(76) Inventor: Masayori Ishimoto, Higashimatsuyama (JP)

Correspondence Address: WENDEROTH, LIND & PONACK, L.L.P., 2033 K STREET N. W., SUITE 800, WASHINGTON, DC, 20006-1021, US

(21) Appl. No.: 10/182,834

(22) PCT Filed: Feb. 2, 2001
(86) PCT No.: PCT/JP01/00732

(30) Foreign Application Priority Data
Jul. 2, 2000 (JP) 2000-28774

(51) Int. Cl. F02M 1/00

(52) U.S. Cl. 123/446; 123/456

(57) ABSTRACT

A fuel injection device, wherein a plurality of high-pressure fuel feed parts each comprising a supply pump part and fuel metering part are disposed, in parallel with each other, between a feed pump part sucking fuel from a fuel tank and a common rail so that the injection of a specified amount of fuel can be maintained even if one high-pressure pump fails, whereby, even if one high-pressure fuel feed parts stops, a common rail pressure can be maintained by the other high-pressure fuel feed part.

### TECHNICAL FIELD

The present invention relates to a fuel injection device having a common rail in which fuel is charged at high pressure, which injects the fuel from a plurality of injection nozzles into the combustion chambers of an internal combustion engine via the common rail.

### BACKGROUND ART

The fuel injection device disclosed in Japanese Unexamined Patent Publication No. H 8-319871, which pressurizes fuel drawn up by a low-pressure pump at a fuel pressurizing unit of a high-pressure pump, feeds the pressurized high-pressure fuel for pressure accumulation and injects the fuel into individual cylinders of the internal combustion engine via injection nozzles connected to the common rail, is characterized by a bypass passage provided to communicate between the outlet of the low-pressure pump and the intake of the common rail by bypassing the fuel pressurizing unit. This feature allows the fuel to be injected to the engine even if the high-pressure pump fails and thus no high-pressure fuel is fed to the common rail.

However, since the fuel injection in sufficient quantity cannot be achieved with the pressure of the fuel supplied from the low-pressure pump, the vehicle cannot travel from the point where the high-pressure pump has failed to a desired point, e.g., a location at which the vehicle does not obstruct the traffic or a repair shop, by maintaining a speed that does not slow down the traffic flow. In addition, there is a problem of a great increase in the quantity of exhaust gas such as black smoke produced by the vehicle traveling in such a state.

Accordingly, an object of the present invention is to provide a fuel injection device capable of maintaining a specific fuel injection quantity even if one of the high-pressure pumps fails.

### DISCLOSURE OF THE INVENTION

In order to achieve the object described above, in the fuel injection device according to the present invention comprising, at least, a fuel tank, a feed pump part that draws up fuel stored in the fuel tank, a fuel metering part that adjusts the feed quantity of the fuel having been drawn up by the feed pump part, a supply pump part that compresses the fuel fed from the fuel metering part so as to achieve a high pressure level, a common rail part, in which the fuel having been compressed to achieve a high pressure level by the supply pump part is stored, and a plurality of injection parts connected to the common rail part, a plurality of high-pressure fuel feed parts constituted of the fuel metering part set between the feed pump part and the supply pump part and the supply pump part are provided in parallel to one another.

It is desirable that the supply pump part be constituted of an inlet valve, an outlet valve, an intake/outlet passage provided between the inlet valve and the outlet valve, a compression space communicating with the intake/outlet passage and a compression mechanism that varies the volumetric capacity of the compression space, and that the fuel metering part be constituted of a fuel passage formed between the feed pump part and the inlet valve of the supply pump part, a throttle valve that opens/closes the fuel passage, a pressure chamber that is formed at one end of the throttle valve and communicates with the fuel passage via an orifice, a spring that is provided at another end of the throttle valve and applies a force to the throttle valve toward the closed position, a fuel return passage that communicates between the pressure chamber and the fuel tank and an electromagnetic valve that opens/closes the fuel return passage. It is to be noted that while the compression mechanism in the present invention adopts a plunger compression system comprising a cylinder that forms a compression space, a plunger that makes a reciprocal movement within the cylinder and a cam shaft having a cam surface that causes the plunger to engage in reciprocal movement, the present invention may be implemented in conjunction with a compression system other than the plunger compression system.

In addition, it is desirable to provide a fuel filter on the outlet side of the feed pump part.

By adopting the structure described above in which a plurality of high-pressure fuel feed parts constituted of the supply pump part and the fuel metering part are provided in parallel to one another between the feed pump part that draws the fuel up from the fuel tank and the common rail, the pressure in the common rail can be sustained through another high-pressure fuel feed part even if one of the high-pressure fuel feed parts stops and thus, a sufficient level of force for driving the engine is assured. Furthermore, since the high-pressure fuel feed parts provided in parallel to one another include the fuel metering part, the quantity of fuel fed through the high-pressure fuel feed part other than the high-pressure fuel feed part that has failed can be increased thereby making it possible to maintain a predetermined quantity of fuel fed to the common rail.

### BRIEF DESCRIPTION OF THE DRAWINGS

FIG. 1 is a schematic diagram showing the structure of the common rail system achieved in an embodiment of the present invention;

FIG. 2 is a partially notched sectional view taken at a side surface of the supply pump assembly achieved in the embodiment of the present invention;

FIG. 3 is a partially notched sectional view taken at the front surface of the supply pump assembly achieved in the embodiment of the present invention; and

FIG. 4 illustrates the structure assumed in the fuel path of the supply pump assembly achieved in the embodiment of the present invention.

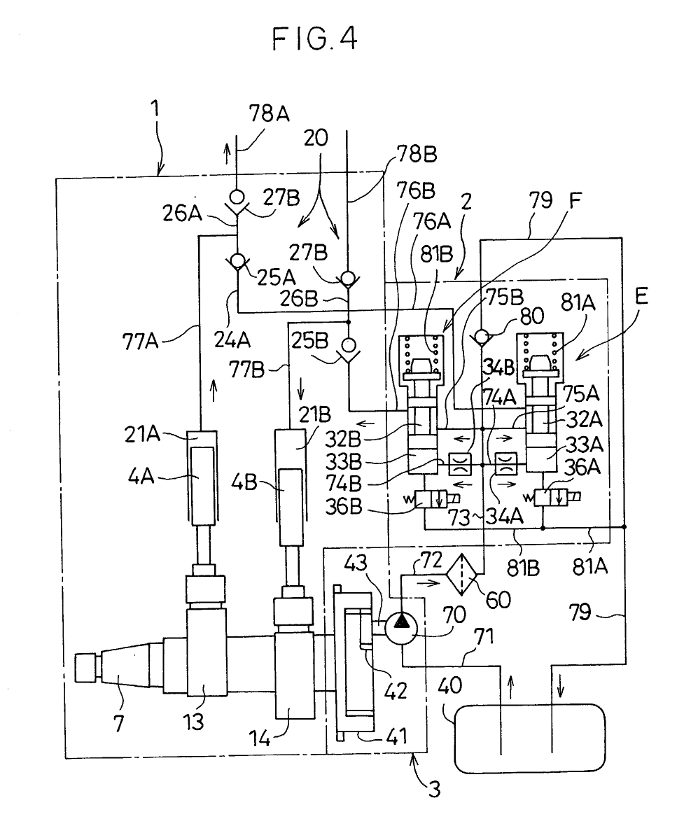

### BEST MODE FOR CARRYING OUT THE INVENTION

The following is an explanation of an embodiment of the present invention, given in reference to the drawings.

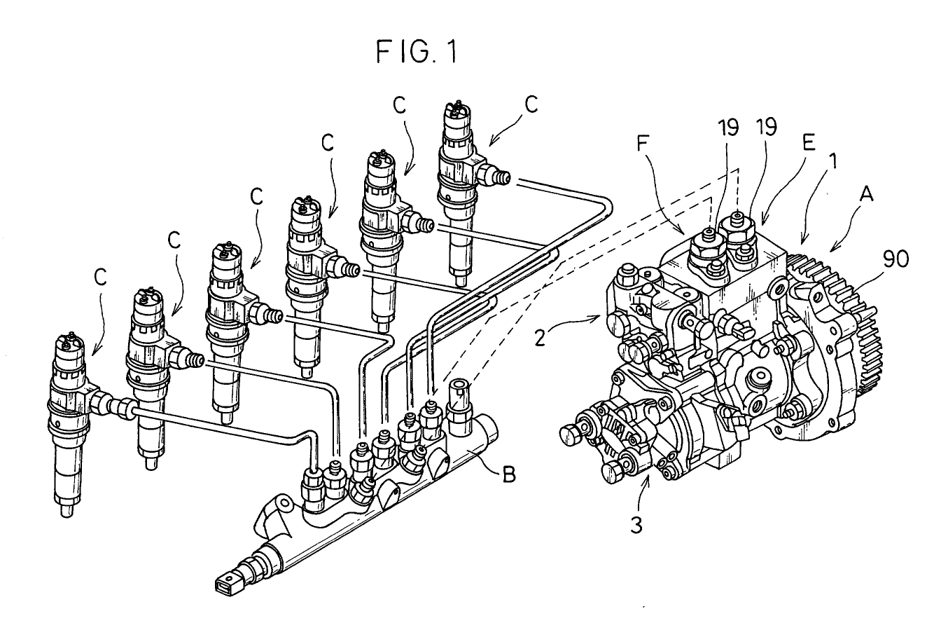

The common rail system shown in FIG. 1 comprises a supply pump assembly A through which high-pressure fuel is supplied, a common rail assembly B in which the pressure from the high-pressure fuel is accumulated and a plurality of injector assemblies C connected to the common rail assembly B. In the present invention, a plurality of high-pressure fuel feed parts are provided at the supply pump assembly A and, more specifically, two high-pressure fuel feed parts E and F are provided in this embodiment

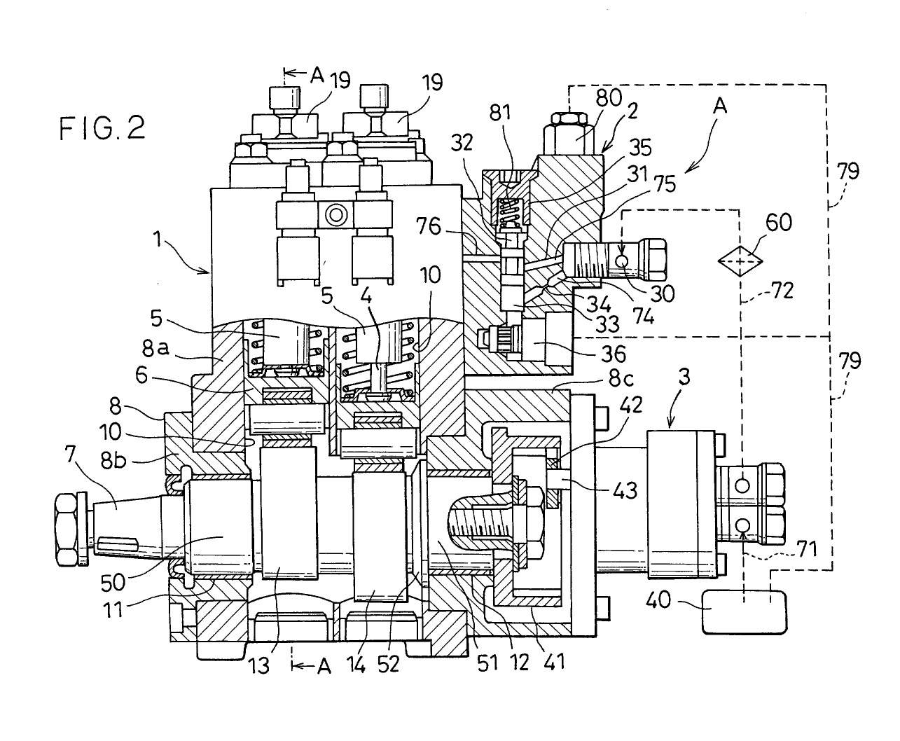

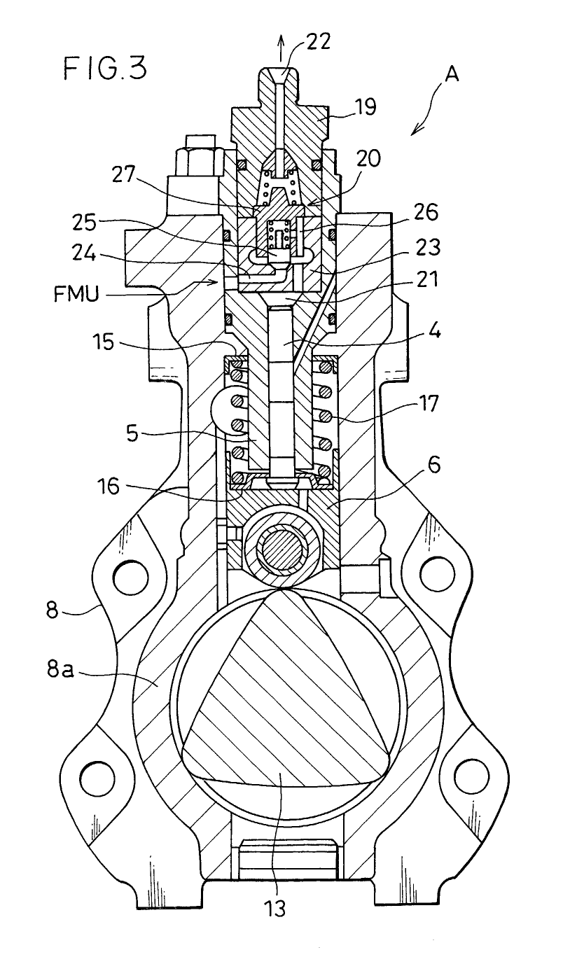

As shown in FIGS. 2 and 3, the supply pump assembly A includes a supply pump part 1 provided inside a housing 8 constituted of housing members at 8a, 8b and 8c, a fuel metering part (FMU) 2 and a feed pump part 3.

The supply pump part 1 comprises a pair of plungers 4, plunger barrels 5 each housing one of the plungers 4 so as to allow the plungers 4 to freely move reciprocally with a compression space 21 defined at one end of the plunger 4, an inlet/outlet valve (IO valve) unit 20 each mounted at an upper part of one of the plunger barrels 5, tappets 6 at each of which the other end of one of the plungers 4 is secured and a cam shaft 7 having a cam surface with which the tappets 6 are placed in contact.

The cam shaft 7 is held along the radial direction with its bearing parts 50 and 51 rotatably supported at the housing members 8b and 8c respectively via radial bearings 11 and 12 and is also held along the axial direction by clamping a part of the housing member 8c between a flange part 52 formed on one side of the bearing part 51 of the cam shaft 7 and an internal gear part 41 of the feed pump part 3 which is to the detailed later secured to the other end of the cam shaft 7. In addition, the cam shaft 7 is caused to rotate by an engine (not shown) with which it is linked via a gear 90 fitted at one end projecting out on the outside of the housing 8, and includes a pair of drive cams 13 and 14 that cause the tappets 6 to engage in reciprocal movement during the rotation.

A pair of longitudinal holes 10 at which the plunger barrels 5 are mounted are formed at the housing member 8a of the pump housing 8, and springs 17 each having one end thereof held at a spring receptacle 15 formed at the housing member 8a and the other end thereof held at a spring receptacle 16 formed at the upper surface of the corresponding tappet are provided at the longitudinal holes 10 to press the tappets toward the drive cams 13 and 14.

The feed pump part 3 comprises a feed pump 70 that draws up the fuel from a fuel tank 40, the internal gear 41 secured to the other end of the cam shaft 7 and provided to drive the feed pump 70 and a drive gear 42 that interlocks with the internal gear 41. It is desirable to constitute the feed pump 70 with a gear pumps that includes a main gear and a slave gear.

As shown in FIG. 2, the fuel metering part 2, which feeds the fuel to the supply pump part 1 after adjusting the feed quantity of the fuel supplied from the feed pump part 3 via a fuel filter 60, comprises a fuel metering fuel passage 31 which communicates between a fuel inlet 30 communicating with the fuel filter 60 and an inflow passage 76 of the IO valve unit 20, a throttle valves 32 opens/closes the fuel metering fuel passage 31, pressure chambers 33 each provided at one end of each throttle valve 32, a pressure detection passages 74 that communicate between the pressure chambers 33 and the fuel inlet 30 via a specific orifice 34, a spring 35 that is provided at the other end of the throttle valve 32 and applies a force to the throttle valve 32 along a direction to close the fuel metering fuel passage 31 and an electromagnetic valve 36 that allows/disallows communication between the pressure chambers 33 and the fuel tank 40.

In addition, as illustrated in FIG. 3, the IO valve unit 20 includes a valve main body 23 having formed therein an inflow fuel passage 24 that communicates with the fuel metering part 2 and an outflow passage 26 that communicates with an inflow/outflow passage 77 communicating with the compression space 21 formed at the front end of the corresponding plunger 4 and also communicates with an outlet passage 78 formed at a delivery valve holder 19 provided at the upper end of the IO valve unit 20, an inlet valve 25 that is provided between the inflow fuel passage 24 and the inflow/outflow passage 77 to allow/disallow the communication between them and an outlet valve 27 that is provided between the inflow/outflow passage 77 and the outlet passage 78 to allow/disallow communication between them.

In the supply pump assembly A structured as described above, the fuel is drawn up into the feed pump 70 from the fuel tank 40 via a fuel pump-up passage 71 and is then fed to the fuel metering part 2 via the fuel filter 60. The fuel having flowed into the fuel metering part 2 via its fuel inlet 30 then flows into a common passage 73, and if an overflow valve 80 provided at its front end is engaged in an operation, the fuel returns from the common passage 73 to the fuel tank 40 via a fuel return passage 79.

In this embodiment, two high-pressure fuel feed parts E and F are formed to extend from the common passage 73 to the common rail assembly B in parallel to each other. It is to be noted that while an explanation is given in reference to the embodiment in which two parallel high-pressure fuel feed parts E and F are provided, the same principle applies to structures having more than two high-pressure fuel feed parts. In the following explanation, A is attached to the reference numerals assigned to components constituting one of the high-pressure fuel feed parts, i.e., the high-pressure fuel feed part E and B is attached to the reference numerals assigned to the components constituting the other high-pressure fuel feed part F.

First fuel passages 75A and 75B constituting part of the fuel metering fuel passage 31 and the pressure detection passages 74A and 74B each extending to the corresponding throttle valves 32 and having the orifice 34 extend from the common passage 73. If the pressure of the fuel supplied from the feed pump 70 is sufficiently high, the pressures inside the pressure chambers 33A and 33B rise via the pressure detection passages 74A and 74B to push the throttle valves 32A and 32B upward against the forces imparted by the springs 35A and 35B to achieve a state of communication between the first fuel passages 75A and 75B at the fuel metering (fuel) passage 31 and second fuel passages 76A and 76B thereby setting the fuel metering (fuel) passage 31 in a continuous state.

Then, if a signal is output from an electronic control unit (ECU) (not shown) to the electromagnetic valves 36A and 36B, the electromagnetic valves 36A and 36B open to allow the pressure chambers 33A and 33B to communicate with corresponding release passages 81A and 81B which communicate with the fuel return passage 79, thereby lowering the pressure levels in the pressure chambers 33A and 33B and thus causing the throttle valves 32A and 32B to move toward the pressure chambers 33A and 33B with the forces imparted by the springs 35A and 35B. Thus, the inlets of the second fuel passages 76A and 76B become constricted or closed off to lower the quantity of the fuel traveling through the fuel metering fuel passage 31. Thus, by controlling the duty ratio (the ratio of the power supply time) for the output signal provided by the ECU to the electromagnetic valves 36A and 36B, the optimal quantity of fuel can be supplied to the IO valve unit 20.

In addition, the second fuel passages 76A and 76B are in communication with the fuel inflow passages 24A and 24B formed at the IO valve unit 20 and, as a result, during an intake process in which the plungers 4A and 4B are lowered and the pressure spaces 21A and 21B expand, the outlet valves 27A and 27B become closed, thereby opening the in light valves 25A and 25B to allow the fuel to be taken into the compression spaces 21A and 21B from the fuel inflow passages 24A and 24B via the inflow/outflow passages 77A and 77B.

During a compression process in which the plungers 4A and 4B are raised and the compression spaces 21A and 21B contract, the inlet valves 25A and 25B become closed, thereby opening the outlet valves 27A and 27B to allow the fuel to be let out into the outlet passages 78A and 78B from the inflow/outflow passages 77A and 77B via the outflow passages 26A and 26B. As a result, the high-pressure fuel is said to the common rail assembly B where the pressure is accumulated. Then, the outlet valve of an injector assembly C having received a specific signal opens and fuel in the common rail assembly B is injected to the cylinder corresponding to the injector assembly C. It is to be noted that since the drive cams 13 and 14 are set at phases offset from each other by 180°, the plungers 4A and 4B alternately feed the high-pressure fuel to the common rail assembly B.

In the structure described above, in which a plurality of high-pressure fuel feed parts E and F are provided between the feed pump part 3 and the common rail assembly B, the required level of engine drive force can be assured even when one of the high-pressure fuel feed parts E and F fails by feeding the high-pressure fuel to the common rail assembly B through the other high-pressure fuel feed part E or F. In addition, since the plurality of high-pressure fuel feed parts E and F are each constituted with the fuel metering part 2 as well as the supply pump part 1, the quantity of fuel supplied to the other high-pressure fuel feed part can be increased if one high-pressure fuel feed part stops, thereby making it possible to assure a sufficient quantity of fuel to be supplied to the common rail assembly B.

### INDUSTRIAL APPLICABILITY

As explained above, according to the present invention having a plurality of high-pressure fuel feed parts constituted with a supply pump part and a fuel metering part provided between a feed pump part and a common rail assembly, a fuel feed can be achieved through another high-pressure fuel feed part even if one high-pressure fuel feed part stops to ensure at least a minimum level of the required engine output so that the vehicle can be moved to a safe location in the event of a failure of a high-pressure fuel feed part.

1. A fuel injection device comprising:
a fuel tank;
a feed pump part that draws up fuel stored in said fuel tank;
a fuel metering part that adjusts the feed quantity of the fuel having been drawn up by said feed pump part;
a supply pump part that compresses the fuel fed from said fuel metering part so as to achieve a high pressure level;
a common rail part, in which the fuel having been compressed to achieve a high pressure level by said supply pump part is stored; and
a plurality of injection parts connected to said common rail part, characterized in that:
a plurality of high-pressure fuel feed parts constituted of said fuel metering part set between said feed pump part and said supply pump part and said supply pump part are provided in parallel to one another.

2. A fuel injection device according to claim 1, characterized in that:
said supply pump part is constituted of;
an inlet valve;
an outlet valve;
an intake/outlet passage provided between said inlet valve and said outlet valve;
a compression space communicating with said intake/outlet passage; and
a compression mechanism that varies the volumetric capacity of said compression space: and
said fuel metering part is constituted of;
a fuel passage formed between said feed pump part and said inlet valve of said supply pump part;
a throttle valve that opens/closes said fuel passage;
a pressure chamber that is formed at one end of said throttle valve and communicates with said fuel passage via an orifice;
a spring that is provided at another end of said throttle valve and applies a force to the throttle valve toward the closed position;
a fuel return passage that communicates between said pressure chamber and said fuel tank; and
an electromagnetic valve that opens/closes said fuel return passage.

3. A fuel injection device according to claim 1 or 2, characterized in that:
a fuel filter is provided on the outlet side of said feed pump part.
